(19) United States
(12) Patent Application Publication
(10) Pub. No.: US 2010/0133191 A1
(43) Pub. Date: Jun. 3, 2010

(54) SUPPORT FOR TANGENTIAL FLOW FILTRATION AND METHOD FOR THE PREPARATION THEREOF

(75) Inventors: Patrick Dupuy, Villeurbanne (FR); Yves Berlier, Montluel (FR); Lionel Tregret, Ste Foy Les Lyon (FR); Didier Dhaler, Tassin La Demie-Lune (FR)

Correspondence Address: HARNESS, DICKEY & PIERCE, P.L.C., P.O. BOX 828, BLOOMFIELD HILLS, MI, 48303, US

(73) Assignee: APPLEXION, Epone (FR)

(21) Appl. No.: 12/623,630

(22) Filed: Nov. 23, 2009

Related U.S. Application Data
(63) Continuation of application No. PCT/FR08/00413, filed on Mar. 26, 2009.

(30) Foreign Application Priority Data
Mar. 26, 2007 (FR) 07 02 169

(51) Int. Cl. B01D 69/10; B29C 51/12; B29C 51/32

(52) U.S. Cl. 210/650; 210/490; 264/279.1; 264/154

(57) ABSTRACT

The disclosure relates to a porous support for tangential flow filtration with a covering surrounding the outer surface of the support, the covering having one or more holes for the evacuation of fluid through the outer surface. The disclosure also relates to a method for preparing such a support.

### CROSS-REFERENCE TO RELATED APPLICATIONS

This application is a continuation of PCT International Application PCT/FR2008/000413, filed on Mar. 26, 2008, which claims priority to French Application 07 02 169, filed on Mar. 26, 2007, both of which are incorporated by reference herein.

### BACKGROUND AND SUMMARY

The present invention relates to a porous support for tangential flow filtration as well as a method for the preparation thereof. The invention relates in particular to such a porous support made of fritted ceramic material, fritted glass, fritted metal or carbon, pierced through by one or more longitudinal parallel channels, the surface of said channels being covered by one or more filter layers made of a ceramic or organic fritted material, in which a liquid to be purified or concentrated, or in general, a fluid to be treated circulates. The porous support and filter layer assembly is hereinafter called a membrane.

In such a device, the fluid to be treated arrives via an inlet chamber at an inlet end of the support or (macro)porous block, flows in the channels until reaching an outlet end, to an outlet chamber; a fraction of liquid or permeate to be treated passes radially through the filter layer and the macroporous support, before collecting in the permeate-side outlet chamber. According to the principle of tangential flow filtration, the liquid to be treated circulates along the channel(s), this flow causing a pressure drop between the inlet and the outlet of said channels. This pressure drop depends on a set of parameters such as for example, the speed of the liquid to be treated or purified in the channel, the viscosity of said liquid, as well as the hydraulic diameter of the channel. This decreasing pressure variation of the liquid to be treated along the channel(s) modifies the transverse flow of the permeate which passes through the filter layer then the macroporous body. There follows a decrease in the transverse pressure drop (transmembrane pressure) which is the difference between the pressure at a point of the channel and the pressure of the permeate chamber, following the direction of circulation of the liquid in the channel(s). This decrease can affect the performance of the filtration device, for example by reducing the permeate flow rate, or by modifying for example the retention threshold, and also, by establishing different filtration regimes along the channel(s).

For example, in a standard membrane having channels of 4 mm diameter, the inlet pressure in the channels is 3.8 bars, the outlet pressure of the channels is 2 bars, while the pressure in the permeate outlet chamber is constant, for example 1.5 bars. Thus, the transverse pressure drop variation along the membrane is between 2.3 and 0.5 bars. With such a standard membrane, the set of dimensional parameters linked to the geometry of the filter element and hydraulic parameters linked to the liquid to be treated and to the operating conditions, do not allow the filtration operation to be fully optimized as it is impossible to attain optimum transverse pressure drop throughout the whole length of the membrane.

Patent U.S. Pat. No. 4,105,547 describes a tangential flow filtration device using a supplementary compensation system of the longitudinal pressure drop. Said complementary system consists in that the outer surface of the support on the permeate side is swept by the permeate which circulates in the same direction as the liquid to be treated in order to create a longitudinal pressure drop in the permeate chamber such that the transverse pressure drop remains approximately constant along the filter.

Patent EP-A-0 333 753 describes an embodiment of this device making it possible to compensate for this transverse pressure drop variation caused by the circulation of a liquid inside one or more channels. As in the previous device, said system consists in that a permeate circulation is established on the outer surface of a tubular membrane, a porous support pierced through by a channel, or a porous block, the latter also pierced through by one or more channels. Such filter media can be assembled singly or in a bundle in a housing where the permeate chamber is filled with a filler body such as balls or granules which cause a resistance to longitudinal permeate flow so as to counterbalance the longitudinal pressure drop variation caused by the circulation of the liquid to be treated in the channel(s) covered by a filter layer.

These two systems according to the prior art require the creation of a permeate recirculation loop actuated by a circulation pump which must be capable of delivering the desired pressure drop. Such systems necessarily use specific housings or enclosures in which a permeate circulation can be established on the outer surface of the filter medium/media in the same direction as that of the liquid to be treated on the inside of the channel(s). These devices of the prior art have several drawbacks, such as:
additional expense of the recirculation loop and its control and regulation system;
energy costs associated with the operation of this additional loop;
additional expense linked to the particular features of the housing(s).

The document EP-A-0 870 534 describes a macroporous support having a permeability gradient according to the direction of flow of the fluid to be treated. This macroporous support preferably has an average porosity gradient at a belt region in the direction of flow of the fluid to be treated, the average porosity increasing in said direction of flow.

The document FR-A-2 846 255 describes a membrane for tangential flow filtration of a fluid to be treated, said membrane comprising a porous support delimiting at least one circulation channel for the fluid to be treated flowing in a given direction between an inlet and an outlet, the inner surface of the porous support delimiting the channel being covered by at least one separation layer for the fluid to be treated, a fraction called permeate passing through the separation layer and the porous support. The support exhibits a variable partial clogging extending from the inner surface of the support on which the separation layer is deposited, said clogging creating, on a given section of the support having a constant thickness, extending from the inner surface of the support, a gradient of average porosity, according to the direction of circulation of the fluid to be treated, the minimum average porosity being situated at the inlet and the maximum average porosity at the outlet.

The document FR-A-2 797 198 describes a membrane for tangential flow filtration of a fluid to be treated, said membrane comprising an inorganic rigid porous support delimiting at least one circulation channel for the fluid to be treated circulating in a given direction, the surface of the channel being covered by at least one layer separating the fluid to be treated, with a fraction called permeate passing through the layer and the support. The separation layer has a reducing thickness gradient in the direction of circulation of the fluid to be treated. These devices of the prior art have several drawbacks, such as:
difficulty of producing the permeability gradient within the porous support or the thickness gradient of the separation layer;
variation of the permeate flow rate throughout the length of the support, the permeate flow favouring an area of greater porosity.

The purpose of the invention is to provide a filtration support that is simpler to prepare. For this purpose, the invention relates to a porous support for tangential flow filtration with a covering surrounding the outer surface of the support, the covering having one or more apertures for fluid discharge via the outer surface.

According to a variant, the covering has several apertures along the support, the gap between two apertures reducing in the direction of flow of the fluid to be treated. According to a variant, the apertures increase in surface area in the direction of flow of the fluid to be treated. According to a variant, the shape of the aperture(s) is chosen from the group comprising rings concentric with the longitudinal axis of the support, a spiral around the longitudinal axis, holes of defined or undefined geometrical shape. According to a variant, the covering material is chosen from a group consisting of a porous material, a polymer, a mixture of polymers or a plastic sleeve.

The invention also relates to a membrane comprising a support as defined above, combined with a filter layer. The invention also relates to a module comprising one or more supports or membranes as defined above. The invention also relates to a method for the preparation of a support as defined above, during which the outer surface of the support is surrounded by a covering and during which apertures are made through the covering.

According to a variant, the outer surface is surrounded by coating the support. According to a variant, the outer surface of the support is partially concealed by masks during the coating, the masks then being removed. According to a variant, the support is immersed in a coating solution by half-lengths. According to a variant, the outer surface is coated by using a system of inking rollers or by spraying. According to a variant, the outer surface is surrounded by thermoforming the covering. According to a variant, the covering is pierced. The invention also relates to the use of a membrane as defined below for tangential flow filtration.

### BRIEF DESCRIPTION OF DRAWINGS

Further characteristics and advantages of the invention will become apparent on reading the following detailed description of the embodiments of the invention, given by way of examples only and with reference to the drawings, which show:

FIG. 1, a support for tangential flow filtration;

FIG. 2, a side view of the support in FIG. 1;

FIGS. 3 and 4, graphs with reference to example 1; and

FIGS. 5 to 9, configurations of membranes and graphs with reference to example 2.

### DETAILED DESCRIPTION

The invention relates to a porous support for tangential flow filtration with a covering surrounding the outer surface of the support; the covering has one or more apertures for fluid discharge via the outer surface. The covering provided with apertures allows the creation of areas favouring the passage of fluid in the support toward the outside. This allows pressure to be created in the support, so as to more simply create a transmembrane pressure.

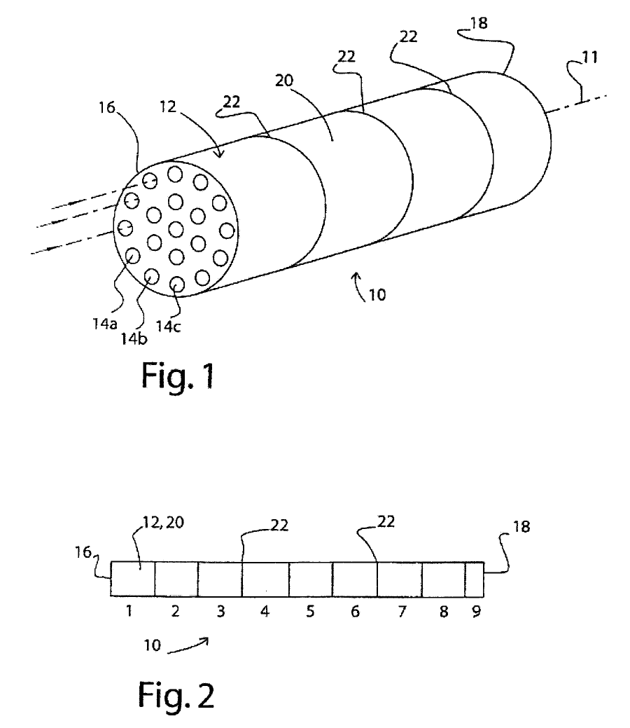

FIG. 1 shows a support 10 for tangential flow filtration. The support 10 shown has an elongated shape along the axis 11. By way of example, the support can be approximately one metre long. The support has a tubular shape. The support can have a circular cross section; the external diameter of the support can be 10 or 25 mm, by way of example. The support 10 can also comprise a cross section having another shape, such as polygonal. The support 10 is outwardly delimited by an outer surface 12. The support 10 is pierced through by one or more channels 14a, 14b, 14c . . . for the fluid to be treated to pass through. The channels can have identical geometry and equivalent hydraulic diameter or variable sizes. The channel(s) is(are) optionally covered by a filter layer, the support and the filter layer forming a membrane. The filter layer is intended to be in contact with the fluid to be treated. The filter layer is characterized by a retention threshold or cut-off threshold; this threshold is related to the size of the filtered molecules in the fluid to be treated. The direction of flow of the fluid to be treated is shown by arrows, so as to delimit an inlet end 16 and an outlet end 18 of the support 10. The fluid to be treated is separated into the permeate, which flows across the support in a direction transversal to the longitudinal axis, and the retentate, which continues its flow along the channels.

Under these operating conditions, a longitudinal pressure drop is established between the inlet end 16 of the support and its outlet end 18 sufficient to allow a fraction of the liquid to be treated which circulates in the channel(s) to pass through the filter layer and the support. The pressure drop is defined so as to obtain a filtration regime compatible with the nature of the liquid to be treated. It is therefore adapted in advance to the circulation speed of the fluid to be treated in the channel(s), the viscosity characteristics and the filtration flow rate of said fluid.

The support 10 moreover comprises a covering or jacket 20 surrounding the outer surface 12 of the support 10. Preferably, the covering is firmly attached to the support, allowing the support equipped with the covering to be placed in a standard module, without adapting the module. However, the covering surrounds the outer surface only partially, inasmuch as not all of the outer surface 12 is surrounded by the covering 20. Areas of the outer surface 12 are left clear. Thus, the fluid flowing radially in the support 10 can flow out of the support via these zones, in particular toward the permeate chamber. This allows a pressure to be created within the support using an element situated outside the support. As the covering 20 only partially surrounds the outer surface, the covering thus has one or more apertures 22 for fluid discharge via the outer surface. When the covering is in place, it is possible to channel the permeate flow within the support toward the apertures; this makes it possible to create pressure at the side of the filter layer facing the support. Thus an excessive pressure difference between each side of the filter layer is avoided, this pressure difference being capable of negatively affecting the filtration quality. This pressure difference also has a negative effect on maintaining the retention threshold (or cut-off threshold), and is therefore damaging to the integrity of the filter layer. High flow rate levels can thus be obtained while providing a suitable separation capability and stability over time.

The apertures 22 are distributed along the support, regularly or not. The shape, the number and the arrangement of the apertures 22 are such that higher filtration performance is obtained than with a support that has no covering. The arrangement, shape and number of apertures are also chosen according to the size of the molecules of the fluid to be treated and the clogging capacity of the fluid to be treated (according to whether water or milk is treated, for example). The apertures 22 can for example be holes on a portion of the circumference of the support or take the form of rings centred around the axis 11 of the support. Preferably, the apertures form a ring, thus ensuring simple preparation of the support. Also, apertures forming a ring allow the symmetry of the support to be retained; at the rings, in cross-section of the support, the pressure in the support is substantially the same. This allows improved control of the permeate flow. The apertures can also be one or more spirals wound around the longitudinal axis of the support; the pitch of the spiral(s)s can be adjusted to regulate the passage of the permeate. The apertures can be holes having a defined geometrical shape such as circular, square or triangular holes, or an undefined shape. The holes can be arranged in rings along the support or in the form of a spiral.

The apertures 22 can be envisaged regularly distributed along the support, spaced apart by an equal distance constituted by the covering 20. Preferably, the distance between two apertures reduces in the direction of flow of the fluid to be treated. The distance between two apertures in the support can reduce continually from one end of the support to the other; alternatively, the distance between two apertures can reduce in stages from one end of the support to the other. The stages can be regular or not. The distance considered is between two adjacent apertures. By adjacent apertures is meant two consecutive apertures, angularly offset or not, along the support.

The advantage of the reducing distance is improved pressure control within the support. In fact, by reducing the distance between the apertures in the direction of fluid flow, it is possible to achieve a pressure reduction in the support, as the fluid flowing transversally is more easily discharged outside the support. Thus, since the pressure in the channels reduces in the direction of flow, it is possible to control the transmembrane pressure, as the pressure in the support can also be reduced; the transmembrane pressure can even be constant along the support by placing the apertures on the outer surface so as to create the same pressure gradient in the support and in the channel. Thus it is possible to maintain the permeate flow rate and the cut-off threshold of the filter layer. The same effects and advantages can be obtained by keeping the distance between the apertures along the support constant but increasing the surface area of the apertures in the direction of flow of the fluid to be treated. These effects and advantages can be further improved by combining the variation in the distance and the surface area of the apertures.

The covering 20 can be tight, inasmuch as the covering 20 does not allow passage of the fluid fraction flowing radially in the support; the covering 20 does not allow the permeate to pass through it. The covering is impermeable to the permeate. In FIG. 1, the fluid flowing radially in the support 10 cannot access the permeate chamber through the covering 20. The material selected for the covering is chosen to allow the permeate to be retained. The covering 20 can be a polymer or a mixture of polymers of the PTFE and Xylene type; it can be a polymer solution reference AS48 from the company SAPPI. The covering 20 can also be a plastic sleeve.

Alternatively, the covering 20 can be porous. The covering then has a cut-off threshold higher than the cut-off threshold of the filter layer. Although the fluid flowing radially in the support is able to be discharged through the porous covering, the favoured fluid flow is toward the fluid discharge apertures. This makes it possible to create a pressure within the support. This has the advantage that the covering 20 can be more solid than previously; in particular, the covering 20 can be more resistant to membrane cleaning solutions. The material used for the covering 20 can be for example the type of material used for the filter layer on the inner surface of the channels.

FIG. 2 shows an embodiment of the support 10. The support 10 comprises an inlet end 16 and an outlet end 18. The support 10 has a porosity for example of 0.1 μm and can comprise 19 channels. The support comprises the outer surface 12 surrounded by the covering 20. The covering 20 delimits apertures 22. In FIG. 2, nine sections of jacket 20 are delimited and separated by an aperture 22. Sections 1 to 7 have a similar dimension, for example 15 cm long, section 8 has a smaller dimension, for example 11 cm long, and section 9 has an even smaller dimension, for example 3 cm long. The apertures 22 are for example 1 mm long. In this example, the apertures have an identical surface area, but are separated by a distance which reduces in stages in the direction of flow. Of course, these dimensions are given by way of example; this type of arrangement will be adapted according to the membrane and the application.

The support can be prepared by a preparation method during which the outer surface of the support 12 is surrounded by the covering 20 and during which apertures are created through the covering. The advantage of the method is that it is simple and thus easily makes it possible to create pressure within the support. Depositing the covering is simpler than in the prior art, where it is necessary to modify the actual porosity of the support. In the present case, depositing the covering on the outer surface of the support is sufficient. The covering can surround the outer surface by thermoforming. The support is then placed in a sleeve and the sleeve thermoformed over the entire length of the support, then apertures are pierced in the sleeve.

Coating can also be used to surround the outer surface 12 of the support 10 with the covering. Coating is preferred to thermoforming, as it is easier to carry out; moreover, coating avoids the problems of the covering detaching itself, which can occur with thermoforming of the covering. Thus, during preparation, it can be arranged for not all of the outer surface to be covered by the covering. The apertures 22 are for example obtained by masking the outer surface 12 with an external sleeve or using rubber bands, the sleeve making it possible to obtain apertures of a larger size. The bands are slipped along the support to the desired locations of the apertures. This has the advantage of easy manipulation. In order to carry out the coating, the support 10 bearing the masks is for example dipped in a coating solution. A preferred procedure is to dip a half-length of support in the coating solution. The advantage of this procedure is that the more-dipped support portions have a dipping time closer to that of the less-dipped support portions. This makes it possible to obtain more even coating of the support, in particular for manual operation. The dipping time is for example a maximum of 4 seconds, preferably 2 seconds.

In order to ensure covering cohesion by the covering 20, the coated support can initially be dried at ambient temperature for a few hours, then dried at 340° C. for 24 hours. In order to avoid coating the inside of the channels of the support, the ends of said support can be blocked.

The supports or membranes as described previously can be placed in a module. The supports or membranes are in communication with a permeate chamber making it possible to collect the permeate discharged by the supports or membranes. The module comprises an installation allowing circulation of the fluid to be treated in the various supports or membranes. The transmembrane pressure is adjusted at the level of the supports or membranes themselves; the advantage is therefore that the module is simple to construct. The support or membranes can even be placed in existing modules, without any particular adaptation. The covering can be applied by any method of covering (or coating) of the spray type or by inking rollers. These methods are automated, allowing a more homogeneous covering to be obtained.

### Example 1

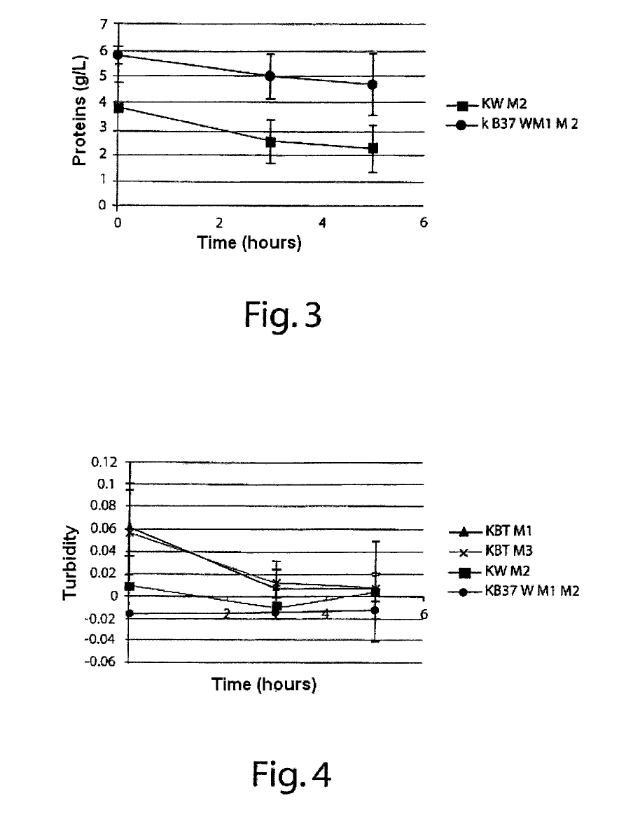

Tests were carried out on Kerasep BW 0.1μ membranes. The product treated is: (conditions used to generate the graphs in FIG. 3)
Cow's milk; raw bulk
Skimmed
Pasteurized
Treatment on membranes at 50+/−2° C.
Concentration factor: 3.4

The hydraulic conditions are:
Membrane Loop 1: membrane which is the subject of the patent
Membrane Loop 2: Standard membrane but having the same geometry

Note: certain tests (turbidity) were also carried out on a module equipped with KBT membranes (27 channels, equivalent hydraulic diameter 2.7 mm).

| | | | | Number of | | | Speed |
|---|---|---|---|---|---|---|---|
| | | Circulation | Equivalent | channels | | | of |
| | Module | flow rate | hydraulic diameter | per | Number of | Shear | sweep |
| | type | m³/h | mm | membrane | membranes | (Pa) | m/sec |
| Loop 1 | KWM1 | 125 | 3.5 | 19 | 37 | 87.00 | 5.13 |
| Loop 2 | KW | 120 | 3.5 | 19 | 37 | 80.00 | 4.90 |

The results obtained are as follows. The essential purpose of these tests is:
To allow the so-called “serous” soluble proteins to pass into the filtrate (or permeate).
To retain the unwanted “casein” cheese proteins.
   FIG. 3 shows the passage of the serous proteins and a comparison of the membranes. In FIG. 3, the KB37WM1M2 curve is the curve obtained with a covered support. The KWM2 curve is the curve obtained with a standard support.

It is noted that the covered support allows improved recovery of the “serous” proteins.

FIG. 4 shows the retention of the caseins and a comparison of the membranes. At this stage, the comparative measurements were carried out by measuring turbidity (colouration of the permeate). The supports of the KBT M1, KBT M3 curves (27 channels) and the KW M2 (19 channels) are not provided with a covering and the KB37 WM1M2 curve is a covered support. It is apparent that the support provided with the covering allows fewer “caseic” cheese proteins into the permeate. With the two FIGS. 3 and 4 it is apparent that improved selectivity is obtained with the covered support.

### Example 2

Tests were carried out on a tangential flow microfiltration pilot comprising:
three stations for installing 3 Kerasep K01 modules (1 monolith per module) in parallel and thus carrying out comparative tests of the membranes on the same product at the same time;
a 100-litre float hopper equipped with a heat exchanger for maintaining the temperature during the tests;
a recirculation pump making it possible to operate at up to 6 m/s tangential speed on 2 K01 modules mounted in parallel;
an electromagnetic flow meter for measuring the recirculation;
manometers for measuring the input/outlet pressure produced and the pressure of the permeate compartment;
pressure regulator valves on the retentate and permeate sides.

A parametric study is carried out to assess the effect of transmembrane pressure on the permeate and retentate flow. During these tests, the transmembrane pressures are gradually increased in stages (+0.2 bar increase with 15-minute stabilization). The flow measurements are carried out by compensated weighting of the density of the product, individually per module. Protein analyses are carried out in a manner which is standard for the dairy industry. The raw material is pasteurized skimmed milk received cold (4° C.) and heated to 50° C. for the tests. The test is started with the permeate compartment full of water in order to have good control of the transmembrane pressure.

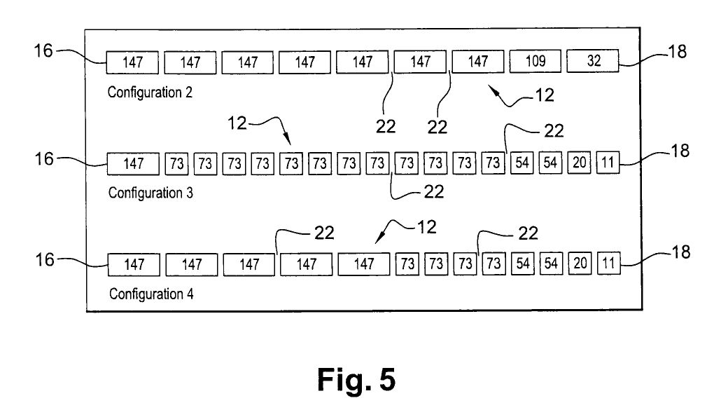

According to FIG. 5, three different membrane configurations are tested. The membranes 12 are covered by a covering 20. The covering 20 comprises apertures 22 in the form of rings arranged lengthwise and centred on the axis 11. The apertures 22 are 1 mm in the direction of flow. The apertures 22 delimit and separate the sections. Configuration 2 comprises nine sections. The first seven sections are 147 mm long, the eighth section is 109 mm and the last section is 32 mm long. Configuration 3 comprises seventeen sections. The first section is 147 mm long, the next twelve sections are 73 mm long, the next two sections are 54 mm long and the last two sections are 20 mm and 11 mm long respectively. Configuration 4 comprises thirteen sections. The first five sections are 147 mm long, the next four sections are 73 mm, the next two sections are 54 mm long, and the last two sections are 20 mm and 11 mm long respectively.

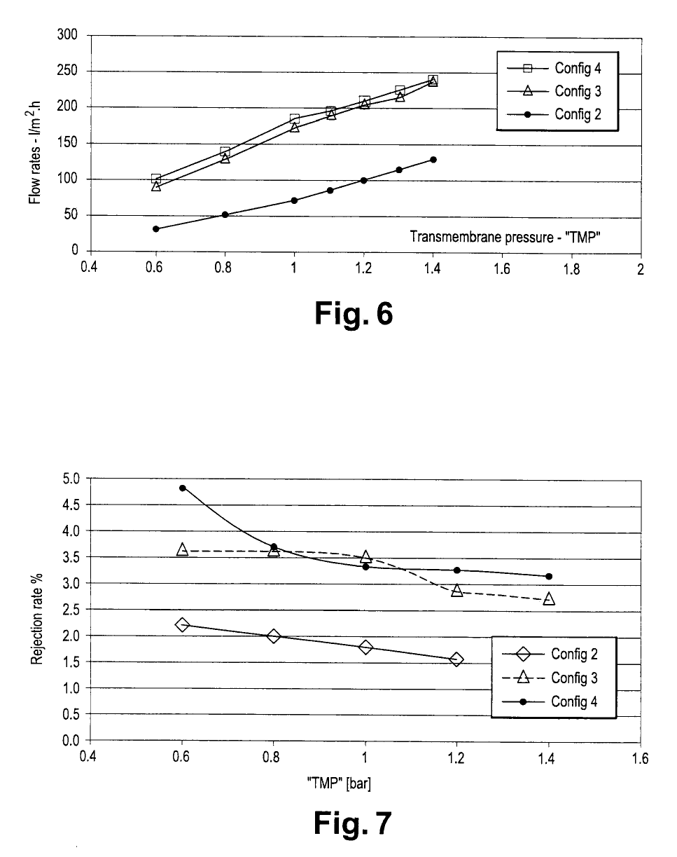

FIGS. 6 and 7 show results on membranes having a cut-off threshold of 0.8μ type. FIG. 6 shows the flow-rate results observed. FIG. 6 shows the flow-rate variation (overall performance of the membrane) as a function of the transmembrane pressure. The treated substance is skimmed milk with a volume concentration factor of 1. FIG. 7 shows the development of the protein rejection rate as a function of the transmembrane pressure on a membrane of 0.8μ. The values observed are below the 5% threshold. An increase in the transmembrane pressure is not reflected in an increase in the protein retention, which is appropriate for the application.

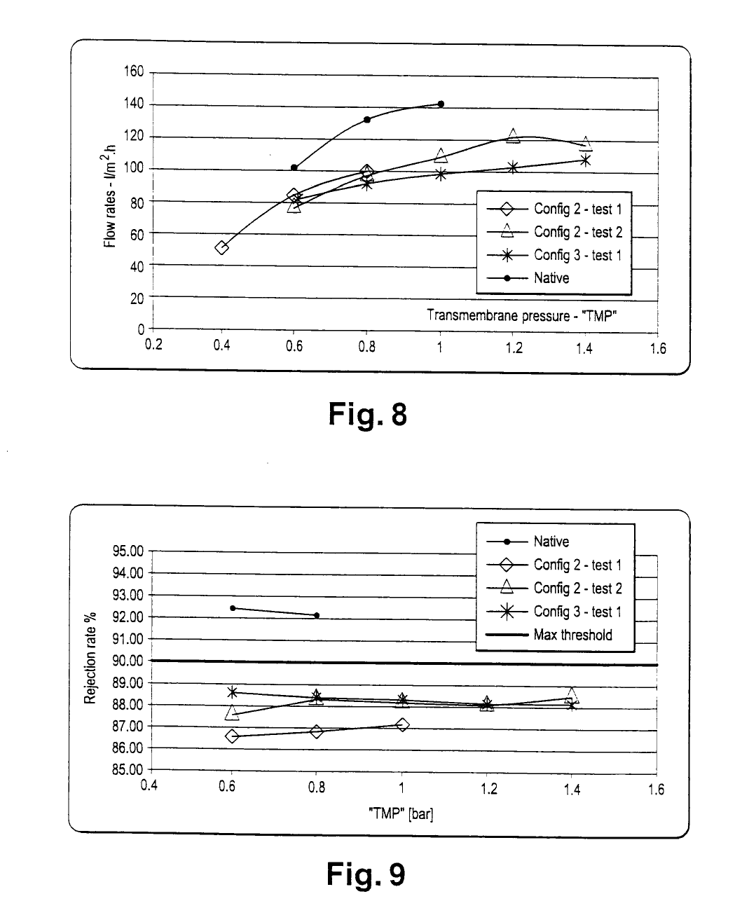

FIGS. 8 and 9 show the results on a membrane with a cut-off threshold of 0.1μ type. The tested membranes are a native membrane (without covering 20), a membrane according to configuration 2 above, and a membrane according to configuration 3 above. FIG. 8 shows the flow-rate variation (overall performance of the membrane) as a function of the transmembrane pressure. The treated substance is skimmed milk with a volume concentration factor of 1. The membrane according to configuration 2 is tested twice. FIG. 9 shows the development of the protein rejection rate as a function of the transmembrane pressure on a 0.1μ membrane. FIG. 9 shows an acceptable 90% threshold in bold lines. Although the flow rate of the membranes provided with a covering is less than the flow rate of the native membrane without a covering, on the other hand the protein rejection rates are only acceptable on the membranes provided with the covering 20.

The invention claimed is:

1. A porous support for tangential flow filtration with a covering surrounding the outer surface of the support, the covering having at least one aperture for fluid discharge via the outer surface.

2. The support according to claim 1, wherein the covering has several apertures along the support, the distance between two apertures reducing in the direction of flow of the fluid to be treated.

3. The support according to claim 1, wherein the at least one aperture has a surface area which increases in the direction of flow of the fluid to be treated.

4. The support according to claim 1, wherein the shape of the at least one aperture is chosen from the group comprising rings concentric with the longitudinal axis of the support, a spiral around the longitudinal axis, holes of definite or undefined geometrical shape, the holes being capable of being in rings or in a spiral.

5. The support according to claim 1, wherein the material of the covering is chosen from a group consisting of a porous material, a polymer, a mixture of polymers or a plastic sleeve.

6. A membrane comprising a support causing tangential flow filtration with a covering surrounding the outer surface of the support, the covering having at least one aperture for fluid discharge via the outer surface, and a filter layer.

7. A module comprising at least one support according to claim 1.

8. A method for the preparation of a support causing tangential flow filtration with a covering surrounding the outer surface of the support, the covering having at least one aperture for fluid discharge via the outer surface, during which the outer surface of the support is surrounded by a covering and during which the at least one aperture is made through the covering.

9. The method according to claim 8, further comprising surrounding the outer surface by coating the support.

10. The method according to claim 9, further comprising partially concealing the outer surface of the support by masks during the coating, and then removing the masks.

11. The method according to claim 9, further comprising immersing the support in a coating solution by half-length.

12. The method according to claim 8, further comprising surrounding the outer surface by a system of at least one of: (a) inking rollers, and (b) by spraying.

13. The method according to claim 8, further comprising coating the outer surface by thermoforming of the covering.

14. The method according to claim 13, further comprising piercing the covering.

15. A use of a membrane according to claim 6 for tangential flow filtration.
